(19) United States
(12) Patent Application Publication
(10) Pub. No.: US 2010/0284089 A1
(43) Pub. Date: Nov. 11, 2010

(54) STACKED OPTICAL GLASS LENS ARRAY, STACKED LENS MODULE AND MANUFACTURING METHOD THEREOF

(76) Inventors: San-Woei SHYU, Taipei (TW); Chien-Min Wu, Taipei (TW); Hsueh-Lin Chen, Taipei (TW)

Correspondence Address: Muncy, Geissler, Olds & Lowe, PLLC, 4000 Legato Road, Suite 310, FAIRFAX, VA, 22033, US

(21) Appl. No.: 12/556,294

(22) Filed: Sep. 9, 2009

(30) Foreign Application Priority Data
May 7, 2009 (TW) 098113127

(51) Int. Cl. G02B 27/12; G02B 11/02; B29D 11/00

(52) U.S. Cl. 359/622; 359/796; 264/1.7

(57) ABSTRACT

A stacked optical glass lens array, a stacked lens module and a manufacturing method thereof are disclosed. The stacked optical glass lens array includes at least two optical glass lens arrays whose optical axis are aligned and then stacked with each other by cement glue in glue grooves. A stacked optical glass lens element can be singularized by cutting along with the alignment notches of stacked optical glass lens array. The stacked lens module is formed by a single stacked optical glass lens element and related optical element mounted in a lens holder. Thereby the optical axis of the lenses of the stacked lens module are aligned precisely, the manufacturing processes are simplified and the production cost is reduced.

### BACKGROUND OF THE INVENTION

The present invention relates to a stacked optical glass lens array, a stacked lens module and a manufacturing method thereof, especially to a stacked lens module formed by a stacked optical glass lens element and other optical elements required mounted in a lens holder. The stacked optical glass lens element is manufactured by cutting a precisely-assembled stacked optical glass lens array. The stacked lens module is applied to assembled lenses of light emitting diode (LED) light sources, assembled lenses of solar energy conversion systems and optical lenses of phone cameras.

Glass precision molding technology has been widely applied to manufacture aspherical molded glass lens with high resolution, good stability and low cost such as lens revealed in US2006/0107695, US2007/0043463, TW095101830, TW095133807, and JP63-295448 etc. A glass preform (or glass material) is set into a mold having an upper mold and a lower mold to be heated and softening. Then the upper mold and the lower mold are clamped correspondingly and apply pressure on the upper mold and the lower mold so as to make the soft glass perform have the same optical surfaces as that of the upper mold and the lower mold. After cooling, a molded glass lens with molding surfaces of the upper mold and the lower mold is producted. In order to reduce manufacturing cost, prior arts—JP63-304201 and US2005/041215 reveal a lens array formed by glass molding. As to a single lens-called a lens element hereunder, JP02-044033 revealed that a lens blank having a plurality of lenses is manufactured by movement of glass materials and multiple molding procedures. Then the lens array is cut into a plurality of lens elements.

The optical lens formed by glass molding is widely applied to assembled lenses of LED light sources, lenses of solar energy conversion systems, and optical lenses of mobile phone cameras. The assembled lens or optical lens is formed by a plurality of optical lenses with different lens power arranged with a certain interval between one another on the optical axis. Thus while assembling, an optical axis of each optical lens must be aligned precisely so as to avoid the reduction of resolution. Moreover, the distance between two adjacent optical lenses (interval) is fixed. Thus the assembling requires a complicated processes and precise calibration process. Therefore, the yield rate is unable to increase and the cost down is difficult. Since the optical resolution (example as MTF effect) will be affected when the optical assembly having disalignment from optical axis, the lens alignment of the optical lens array is more complicated and important. As to the manufacturing of the optical lens array, JP2001194508 disclosed a manufacturing method of plastic optical lens array. Taiwanese patent No. M343166 reveals a manufacturing method of glass optical lens array. After being produced, the optical lens array can be cut to form a single optical lens element so as to be assembled in a lens module. Or the optical lens array is assembled with other optical elements to form a lens submodule array that is then cut to form a lens submodule. The lens submodule is assembled with lens holder, image sensors (image capture devices) or other optical elements to form a lens module.

In manufacturing of lens module array, wafer level lens modules are revealed in U.S. Pat. No. 7,183,643, US2007/0070511, WO2008011003 and so on. Refer to FIG. 1, a lens module array generally includes an aperture 711, a cover glass 712, a plurality of optical lenses and an infrared (IR) cut lens 717. As shown in figure, the plurality of optical lenses forms a three piece type optical lens set. The optical lens set includes a first optical lens 714, a second optical lens 715 and a third optical lens 716. Two adjacent optical lenses are separated by a spacer 713. After being assembled, a lens module array is formed and then is cut into a plurality of lens modules. Moreover, as shown in FIG. 2, a lens module disclosed in WO2008/063528 is formed by a stacking way. An aperture 711, a first optical lens 714, a spacer 713, a second optical lens 715, a spacer 713, a third optical lens 716, an image sensor 717 and a circuit board 718 are packaged in an encapsulant 719 to a lens module.

In a lens module array, while assembling a lens array with plurality of optical lenses, the alignment of the lens array has effects on resolution of the lens module. In US2006/0249859, imaging techniques are used to determine if stacked wafers are in proper alignment. Fiducial marks that were previously patterned on each wafer of the stack are exposed in an image produced by the infrared ray. In assembling of plastic optical lens arrays, JP2000-321526 and JP2000-227505 revealed bi-convex type optical lens arrays formed by combination of heights with crevices. As to U.S. Pat. No. 7,187,501, cone-shaped projections are provided on a periphery of a resin lens. A plastic lens array is formed by stacking the resin lens plates one over another through fitting these projections and holes to each other. However, in the conventional assembling way of projections and holes to form plastic optical lens array, material shrinkage after the plastic injection molding will lead to size change of the projections and the holes. Thus the location precision is affected and the alignment of the optical axis is difficult. Therefore, the applications of the plastic optical lens array is limited, especially during manufacturing of small-size lens module, the complicated processes cause cost increase. The molded glass lens has higher refractive index than the plastic lens and also with better thermostability so that the molded glass has been applied to various optical systems. Moreover, the optical lens array made from molded glass exhibit less shrinkage.

Thus there is a need to develop a method of manufacturing stacked optical glass lens arrays as well as stacked lens modules with simple structure and high precision so as to provide stacked lens modules for assembled lenses of light emitting diode (LED) light sources, assembled lenses of solar energy conversion systems and optical lenses of phone cameras. And the lens modules meet requirements of mass-production and yield rate.

### SUMMARY OF THE INVENTION

Therefore it is a primary object of the present invention to provide a stacked optical glass lens array applied to optical lenses of optical systems. The stacked optical glass lens array includes at least two optical glass lens arrays stacked with each other by glue with a preset interval there between. The optical glass lens arrays are produced by multi-cavity glass molding and having optical area and non-optical area. At least one of the optical glass lens arrays is disposed with at least one glue groove along a periphery of the non-optical area. The glue groove 111 is filled with glue so that two adjacent assembled lens arrays are fixed and stacked to each other after curing of the cement glue.

It is another object of the present invention to provide a stacked optical glass lens array applied to optical lenses of optical systems. The stacked optical glass lens array includes at least two optical glass lens arrays stacked with each other by glue with a preset interval there between. At least one of the optical glass lens array is disposed with at least one alignment notch along a periphery of the non-optical area. By the alignment notch, the optical glass lens array is cut and singularized into a plurality of single stacked optical lens element that is applied to stacked lens modules.

It is a further object of the present invention to provide a stacked lens module having at least one stacked optical lens element, a lens holder and other related optical element. The stacked optical lens element is made by cutting of a stacked optical glass lens array. The related optical elements can be an optical lens, a spacer, an aperture, a cover glass, an IR-cut glass, an image sensor, a photoelectric device, a circuit board (such as printed circuit board PCB) or their combinations.

It is a further object of the present invention to provide a manufacturing method of the stacked optical glass lens array and the stacked lens module having following steps:

S1: providing a glass blank;

S2: providing a first optical surface mold and a second optical surface mold of a lens array while respective optical surface mold having an optical surface molding surface; the first and/or the second optical surface mold is further disposed with glue groove on the molding surface;

S3: setting the glass blank into the first and the second optical surface molds so as to form an optical glass lens array by being heated by a heater and being pressured while the optical glass lens array having optical area with optical surface and non-optical area with the glue groove;

S4: manufacturing another optical glass lens array according to the above steps and arranging at least one alignment notch molding surface at the first optical surface mold or a second optical surface mold in the step S2 or step S4 so as to form at least one alignment notch on the non-optical area;

S5: applying cement glue to the glue groove between two adjacent optical glass lens arrays,

S6: using a laser beam for alignment of optical axis of the two adjacent optical glass lens arrays;

S7: curing the cement glue to form a stacked optical glass lens array with a precisely aligned optical axis;

S8: cutting the stacked optical glass lens array along alignment marks formed by alignment notches to produce a plurality of stacked optical lens elements while the alignment marks is formed by alignment notches;

S9=assembling the stacked optical lens element into a lens holder, so as other related optical element so as to form a stacked lens module.

In accordance with the above method, an optical glass lens array, a stacked optical glass lens array and a stacked lens module are manufactured precisely so as to achieve purposes of precise assembling and mass production.

### BRIEF DESCRIPTION OF THE DRAWINGS

FIG. 1 is a schematic drawing showing a conventional optical glass lens module array;

FIG. 2 shows packaging of a conventional lens module;

FIG. 3 is an embodiment of a stacked optical glass lens array according to the present invention;

FIG. 4 is a top view showing alignment notches of a part of stacked optical glass lens array according to the present invention;

FIG. 5 show a top view and a cross sectional view of a first optical surface mold according to the present invention;

FIG. 6 show a top view and a cross sectional view of a second optical surface mold according to the present invention;

FIG. 7 show a top view and a cross sectional view of a third optical surface mold according to the present invention;

FIG. 8 show a top view and a cross sectional view of a fourth optical surface mold according to the present invention;

FIG. 9 is a manufacturing flow chart of manufacturing a stacked optical glass lens array and a stacked lens module according to the present invention;

FIG. 10 is a schematic drawing showing alignment of optical axis of a stacked optical glass lens array according to the present invention;

FIG. 11 shows a stacked optical glass lens array being singularized into a plurality of single stacked optical lens element according to the present invention;

FIG. 12 shows a stacked optical glass lens array applied to solar energy conversion modules;

FIG. 13 shows a stacked optical lens element applied to lens modules of mobile phone cameras;

FIG. 14 shows a stacked optical lens element applied to zoom lens modules of cameras.

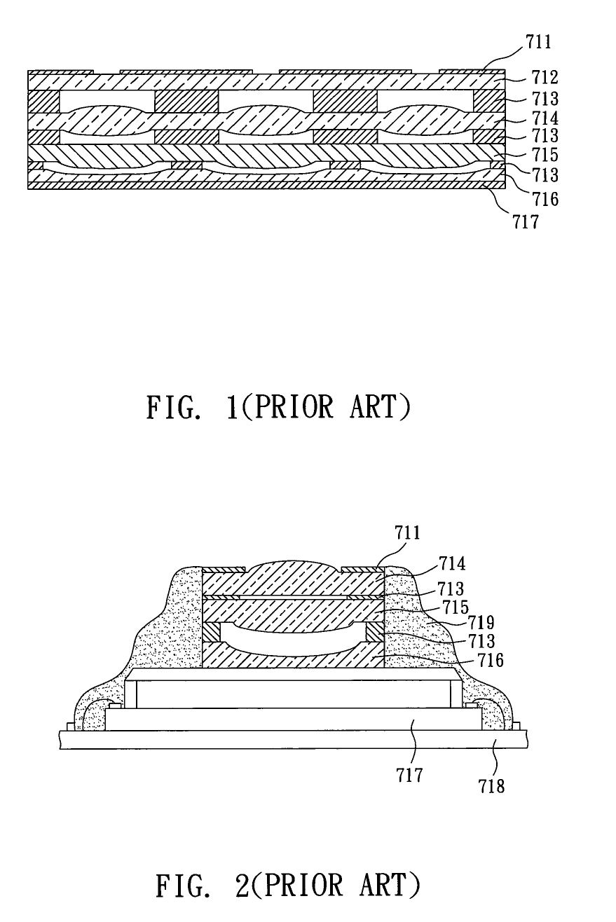

### DETAILED DESCRIPTION OF THE PREFERRED EMBODIMENT

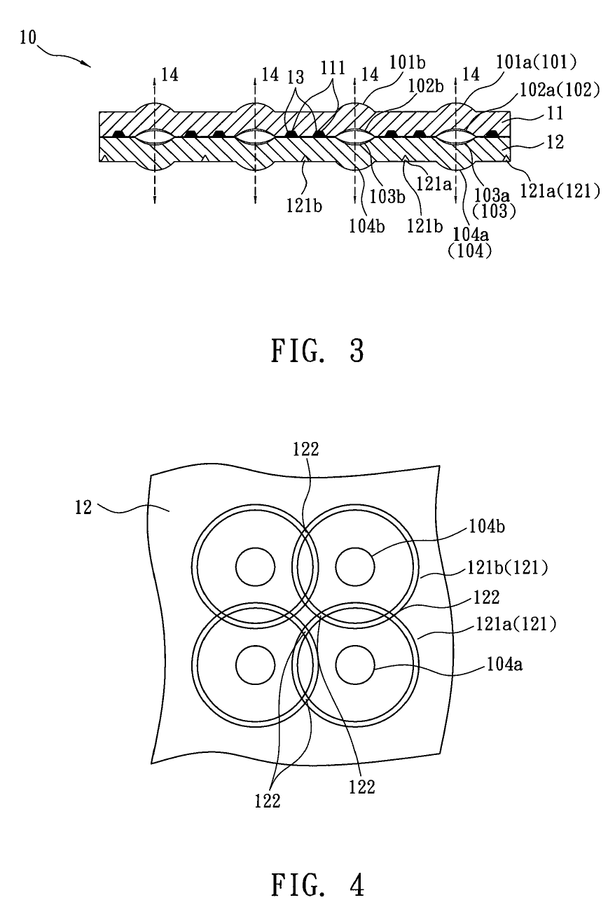

A stacked optical glass lens array of the present invention includes at least two optical glass lens arrays that are assembled with a certain interval by cement glue. As shown in FIG. 3, a first optical glass lens array 11 and a second optical glass lens array 12 are made by multi-cavity glass molding and each having optical area and non-optical area. The first lens array 11 is disposed with glue grooves 111 filled with cement glue 13 along the circumference of non-optical area of second optical surfaces 102 (102a, 102b, . . . ). The glue groove 111 is a circular slot. The two adjacent assembled optical glass lens arrays 11, 12 are stacked to each other and respective optical axis 14 is aligned with each other by curing of the cement glue 13 in the glue groove 111 so as to form a stacked optical glass lens array 10.

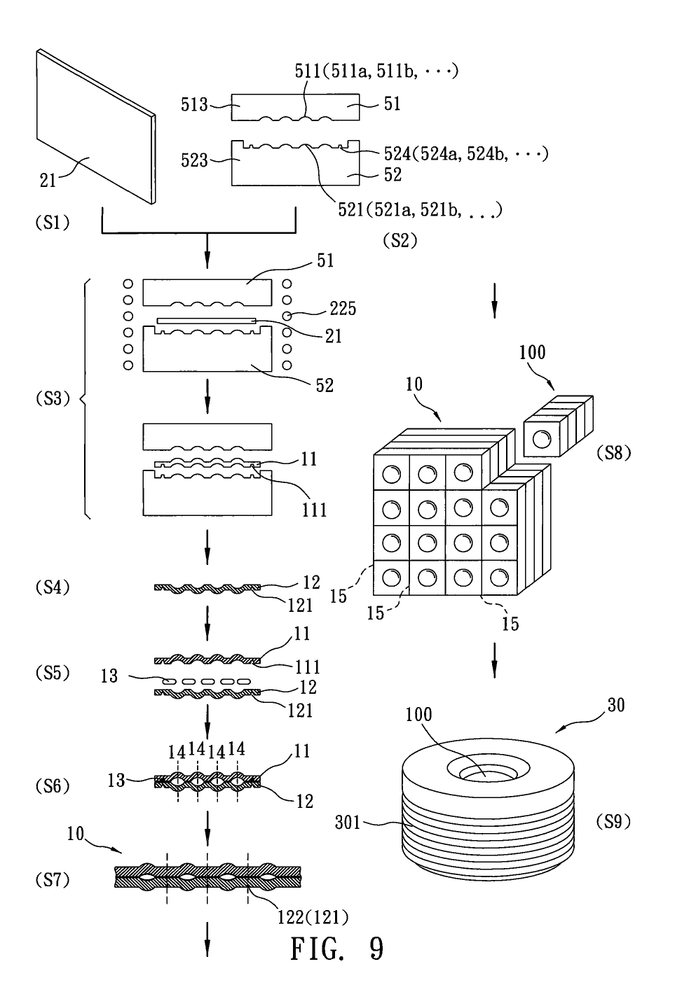

The second lens array 12 includes alignment notches 121(121a, 121b, . . . ) disposed on a circumference of non-optical area of fourth optical surfaces 104 (104a, 104b, . . . ). The alignment notch 121 can be a circular V-shaped slot whose center of a circle is located on optical axis 14 of the fourth optical surface 104 (104a, 104b, . . . ). Moreover, the diameter of each alignment notch 121 can be the same. Then intersection points of two adjacent alignment notches 121(121a, 121b, . . . ) form two alignment marks 122, as shown in FIG. 8. Thus along the alignment marks 122, the lens array 10 is cut precisely and singularized into a plurality of single stacked glass lens element 100, as the step S8 in FIG. 9.

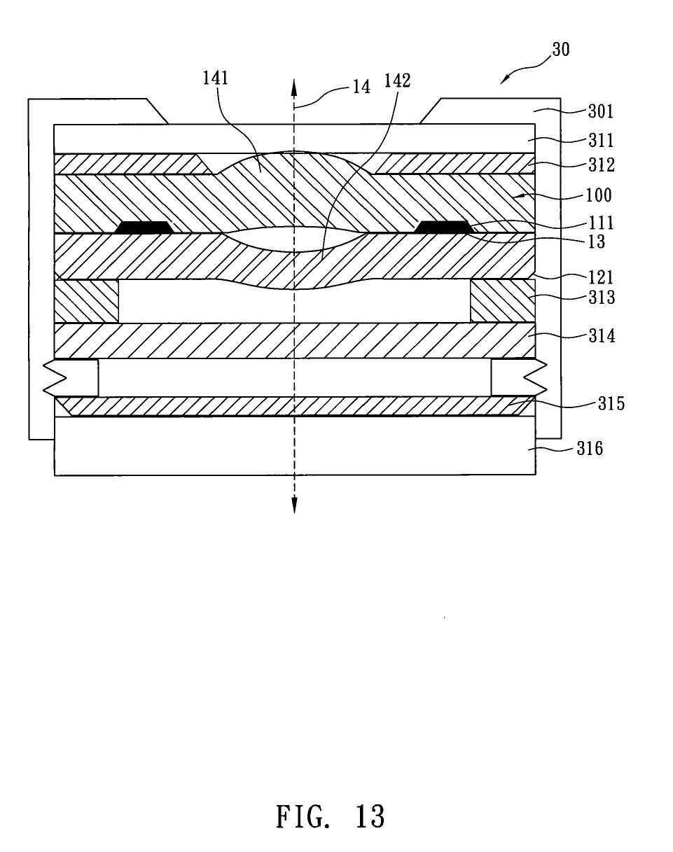

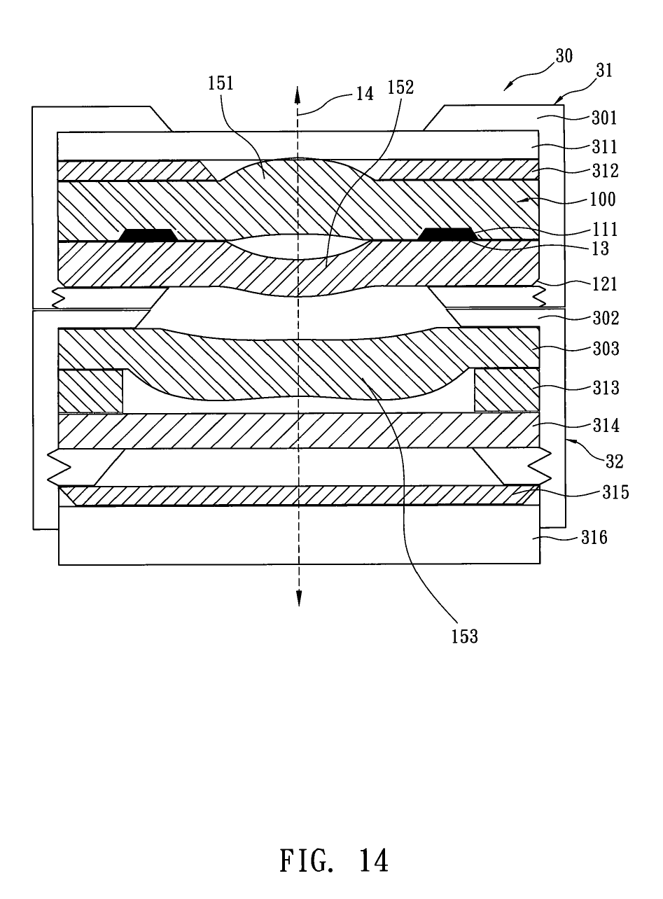

A stacked lens module 30, as shown in FIG. 13, the stacked glass lens element 100 and various optical elements (as 311, 312, 313, 314, 315) are mounted into a lens holder 301.

The shape and pattern of the glue groove 111 are not restricted in the circular slot. The shape and pattern of the alignment notches 121 are not limited to a circular V-shaped slot. The optical elements are not limited to optical lenses, spacers, apertures, cover glasses, IR cut lenses, image sensors, photoelectric devices, and circuit boards.

### Embodiment One

Refer to FIG. 3, this embodiment is a stacked optical glass lens array that includes a first optical glass lens array 11 and a second optical glass lens array 12, stacked with each other by cement glue 13. The first lens array 11 is disposed with 4×4 first optical surfaces 101 (101a, 101b, . . . ) and 4×4 second optical surfaces 102 (102a, 102b, . . . ). The second optical surface 102 is arranged with 4×4 circular glue grooves 111 whose cross section is a trapezoid. The second lens array 12 is disposed with 4×4 third optical surfaces 103(103a, 103b, . . . ) and 4×4 fourth optical surfaces104(104a, 104b, . . . ).

While being assembled, the second lens array 12 is mounted into an assembly fixture (not shown in figure). Then each glue groove 111 of the first lens array 11 is filled with the cement glue 13 such as thermoset adhesive and the first lens array 11 is set into the assembly fixture, stacked over the second lens array 12. Thus the first and the second lens arrays 11, 12 are fixed in the assembly fixture to be sent into an oven for curing of the cement glue 13 so as to form a stacked optical glass lens array 10 with an aligned optical axis 14.

### Embodiment Two

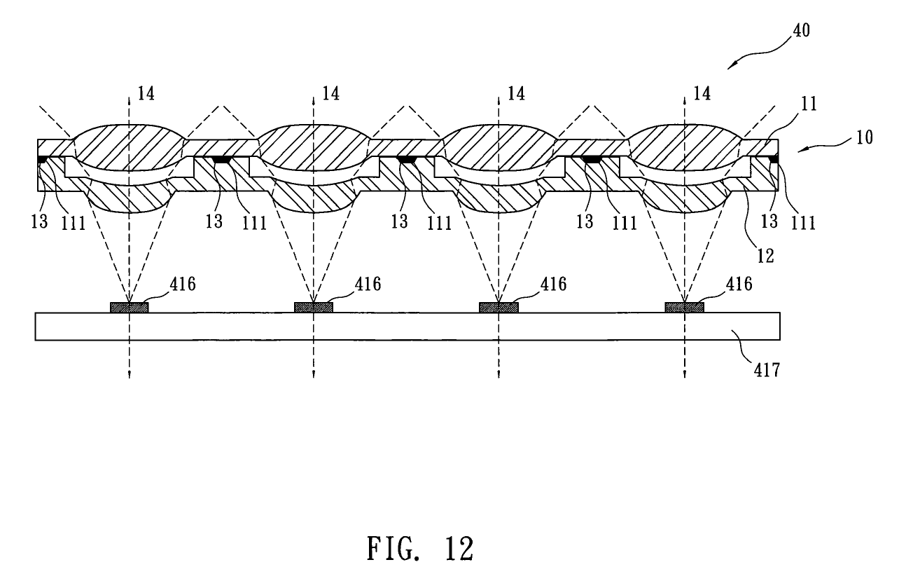

Refer to FIG. 12, a stacked optical glass lens array in this embodiment is applied to solar energy conversion systems. In order to get excellent solar energy conversion efficiency, a solar transformation module 40 often includes a plurality of optical glass lens arrays so as o make solar light focus on the photoelectric die 416. Thus solar energy is converted into electricity by the photoelectric die 416 and then the electricity is output through a circuit board 417. The solar transformation module 40 consists of a stacked optical glass lens array 10 formed by two optical glass lens arrays 11, 12, a circuit board 417, and a plurality of photoelectric die 416 arranged over the circuit board 417. The stacked optical glass lens array 10, the same as the embodiment one, the first lens array 11 and the second lens array 12 respective include 4×4 corresponding meniscus optical area. In order to make the stacked optical glass lens array 10 have optimal focusing effect, a certain interval is maintained between the first and the second lens arrays 11, 12. In this embodiment, the distance between an image-side convex surface of the first lens array 11 and an object-side concave surface of the second lens array 12 is 0.5 mm while the distance between an image-side convex surface of the second lens array 12 and the photoelectric die 416 is 10 mm. Moreover, the center of each photoelectric die 416 is aligned with the corresponding optical axis 14 of the stacked optical glass lens array 10 so that sunlight passing through the stacked optical glass lens array 10 focuses on the photoelectric die 416.

### Embodiment Three

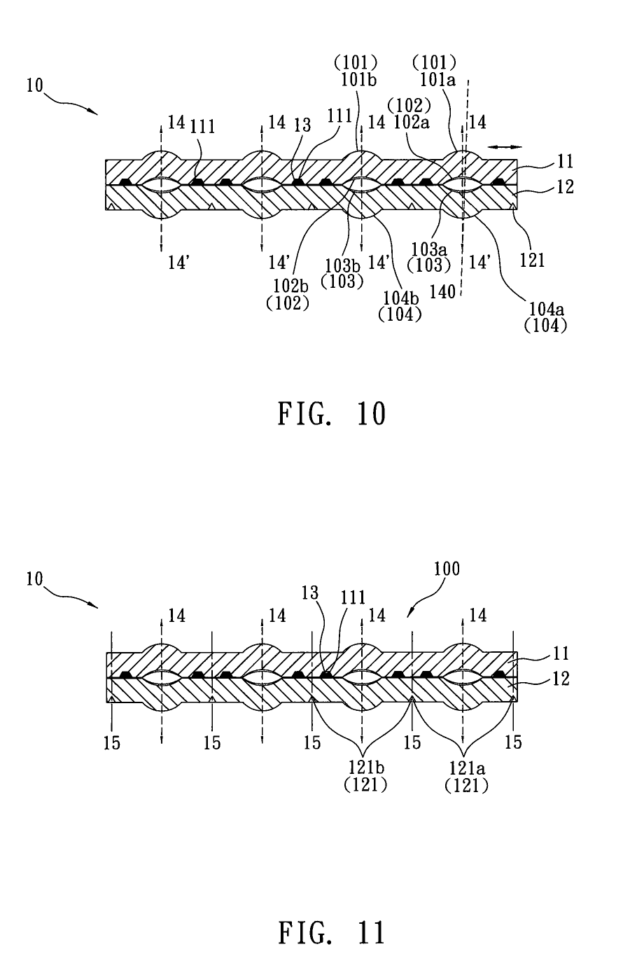

Refer to FIG. 10 and FIG. 11, a stacked optical lens element 100 of this embodiment formed by cutting and singularizing of a stacked optical glass lens array 10 is applied to high-precision mobile phone lenses. The stacked optical glass lens array 10 includes a first optical glass lens array 11 and a second optical glass lens array 12, stacked with each other by cement glue 13. The first lens array 11 is disposed with 4×4 first optical surfaces 101 (101a, 101b, . . . ) and corresponding 4×4 second optical surfaces 102 (102a, 102b, . . . ). The second optical surface 102 is arranged with 4×4 glue grooves 111 that is circular and with a trapezoid cross section. The second lens array 12 is disposed with 4×4 third optical surfaces 103(103a, 103b, . . . ) and 4×4 corresponding fourth optical surfaces 104(104a, 104b, . . . ). The fourth optical surface 104 is formed with 4×4 circular V-shaped alignment notches 121(121a, 121b, . . . ) and the center of each alignment notch 121 is on an optical axis 14 of each corresponding fourth optical surface 104(104a, 104b, . . . ).

For being applied to high precision mobile phone lenses, while assembling the stacked optical glass lens array 10, the optical axis 14 of the first lens array 11 as well as that of the second lens array 12 must be aligned so as to meet requirement of tolerance. When being assembled, the second lens array 12 is set into an assembly fixture (not shown in figure). Then the glue groove 111 of the first lens array 11 is filled with cement glue 13 and then is put into the assembly fixture to be arranged over the second lens array 12. Next use a laser beam 140 for alignment of optical axis. When a laser light 140 penetrates through the optical axis 14′ of the second lens array 12, it aligns with the optical axis 14′. Then move the first lens array 11 horizontally so as to make the laser light 140 align with the optical axis 14 of the first lens array 11. Thus the alignment of the two optical axis 14′, 14 is finished. The alignment is performed only on 4×4 diagonal position.

In this embodiment, the cement glue 13 is an ultraviolet (UV) curing adhesive. After alignment of the optical axis 14′, 14, the first and the second lens arrays 11, 12 are fixed inside the assembly fixture to be sent into an UV curing oven for curing of the cement glue 13 and formation of a stacked optical glass lens array 10.

Refer to FIG. 11 and FIG. 4, the fourth optical surface 104 is disposed with 4×4 circular V-shaped alignment notches 121(121a, 121b, . . . ). By two adjacent alignment notches 121 such as 121a and 121b, two alignment marks 122 are formed, as shown in FIG. 4. Connect the two alignment marks 122 to form a dicing line 15 and use a diamond grinding wheel to cut along the dicing line 15 so as to get 16 stacked optical lens elements 100. The optical axis of the first, the second, the third, and the fourth optical surfaces have been aligned of each stacked optical lens element 100 have been aligned and each stacked optical lens elements 100 has the same shape and the same size so as to be applied to mobile phone lenses.

### Embodiment Four

Refer to FIG. 13, a stacked optical lens element 100 of this embodiment is applied to a lens module 30 for camera phones. The lens module 30 consists of a stacked optical lens element 100, a lens holder 301 and other related optical elements having a cover glass 311, an aperture 312, a spacer 313, an IR-cut glass 314, an image sensor 315 and a circuit board 316.

The application of this embodiment is similar to the embodiment three. Firstly prepare a stacked optical lens element 100 having a first lens element 141, a second lens element 142 and at least one glue groove 111. Also prepare a lens holder 301. Then set the cover glass 311, the aperture 312, the lens element 100, the spacer 313 and the IR-cut glass 314 into the lens holder 301. Next the circuit board 316 with the image sensor 315 is assembled with the lens holder 301 so as to form a complete lens module 30. Thereby the lens module 30 is manufactured quickly and conveniently. And the lens module 30 can be mass-produced and the manufacturing cost can be reduced dramatically.

### Embodiment Five

Refer to FIG. 14, a stacked optical lens element 100 of this embodiment is applied to lens modules 30 of camera zoom lenses. In order to achieve zooming, optical lens group is formed by a plurality of optical lenses. By changing distance between different optical lenses groups, the zooming is achieved. In this embodiment, the lens module 30 is composed of a first optical lens group 31 and a second optical lens group 32. The first optical lens group 31 includes a stacked optical lens element 100, a lens holder 301 and a plurality of other related optical elements. The stacked optical lens element 100 is formed by a first optical glass lens element 151 and a second optical glass lens element 152. The other related optical elements include a cover glass 311 and an aperture 312 while the second optical lens group 32 includes a third optical plastic lens element 153, a lens holder 302 and other related optical elements having a spacer 313, an IR-cut glass 314, an image sensor 315 and a circuit board 316.

The application of this embodiment is similar to the embodiment three. Firstly, produce the stacked optical lens element 100 that includes the first optical glass lens element 151, the second optical glass lens element 152 and the glue groove 111. Also prepare a lens holder 301 in advance. The cover glass 311, the aperture 312, the stacked optical lens element 100 are assembled in the lens holder 301 to form the first lens group 31. Moreover, the third optical plastic lens element 153 is made by injection molding and also prepare a lens holder 302. The third optical plastic lens element 153, the spacer 313, the IR-cut glass 314 are assembled in the lens holder 302 in order and then the circuit board 316 preset with the image sensor 315 is also mounted in the lens holder 302 to form the second lens group 32.

In use, the first lens group 31 is mounted in a lens barrel (not shown in figure). By movement of the first lens group 31, the zooming is achieved. Thereby the lens module 30 is produced conveniently and fast. This allows mass production and the manufacturing cost is reduced.

### Embodiment Six

The stacked optical glass lens array 10 and the stacked glass lens element 100 as embodiment three are manufactured in this embodiment. Refer to FIG. 9, set a glass blank 21 into a multi-cavity first optical surface mold 51 and second optical surface mold 52. The molds 51, 52 are heated by a heater 225 and also are applied with pressure so as to produce a first lens array 11 by molding processes. A second lens array 12 is manufactured by the same way.

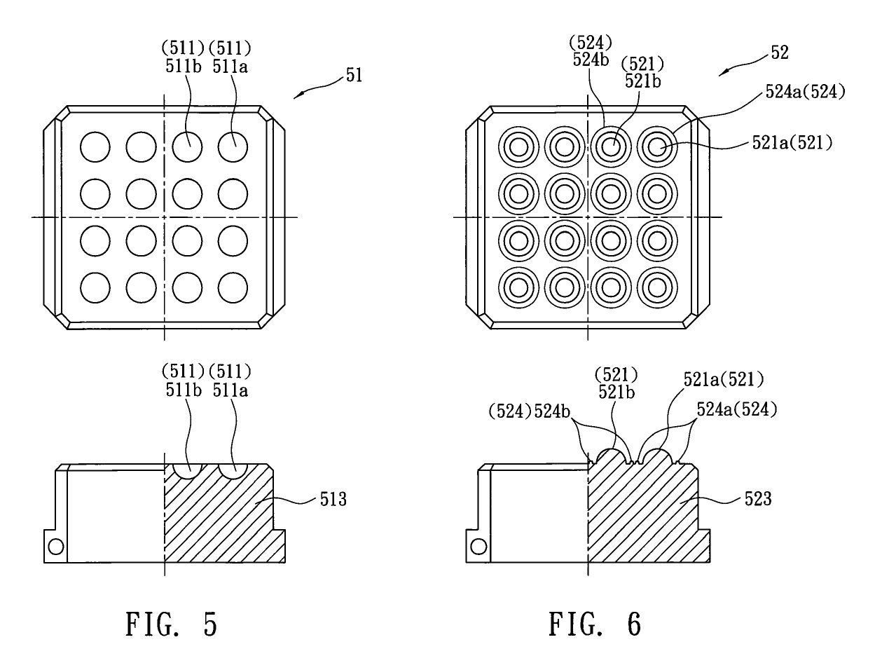

The mold of the first lens array 11 is shown in FIG. 5 and FIG. 6. A first optical surface molding surface 511 (511a, 511b, . . . ) is disposed on a mold base 513 of the first optical surface mold 51. The molding surface 511 is a concave surface and is arranged to form a 4×4 array. The distance between two adjacent molding surfaces 511(511a′ 511b . . . ) is the same. The 4×4 first optical surface 101 is produced by glass molding. A second optical surface molding surface 521 (521a, 521b . . . ) is disposed on a mold base 523 of the second optical surface mold 52. The molding surface 521 is a convex surface and is arranged to form a 4×4 array. At least one glue groove molding surface 524 (524a, 524b . . . ) that is circular and with a trapezoid cross section is arranged at a periphery of the second optical surface molding surface 521 (521a, 521b . . . ) so as to form a circular glue groove 111.

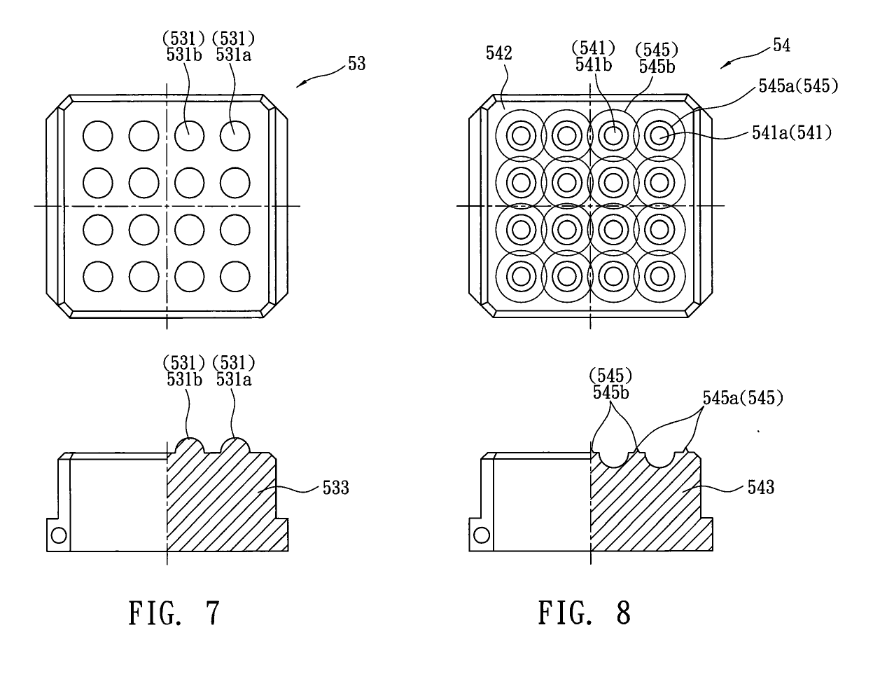

The mold of the second lens array 12 is shown in FIG. 7 and FIG. 8. A third optical surface molding surface 531 (531a, 531b . . . ) is disposed on a mold base 533 of the third optical surface mold 53. The molding surface 531 is a convex surface and is arranged to form a 4×4 array. The distance between two adjacent molding surfaces is the same so that 4×4 third optical surfaces 103 are produced. A fourth optical surface molding surface 541 (541a, 541b . . . ) is disposed on a mold base 543 of the fourth optical surface mold 54. The molding surface 541 is a concave surface and is arranged to form a 4×4 array. The distance between two adjacent molding surfaces is the same so that 4×4 fourth optical surfaces 104 are produced. Alignment notch molding surfaces 545 (545a′ 545b . . . ) these are circular V-shaped convex surfaces with center on the optical axis of the fourth optical surface are disposed on the periphery of the fourth optical surface molding surface 541 (541a, 541b . . . ). The radius and V-shaped convex surface of each alignment notch molding surface are the same with one another.

Refer to FIG. 9, a manufacturing method of a stacked optical glass lens array 10 and of a stacked optical glass lens element 100 includes the following steps:

S1: provide a glass blank 21,

S2: provide a first optical surface mold 51 and a second optical surface mold 52 of an optical lens array while respective optical surface mold having a first optical surface molding surface 511 (511a, 511b, . . . ) and a second optical surface molding surface 521(521a, 521b, . . . ), the second optical surface mold 52 is further disposed with the glue groove molding surface 524(524a, 524b, . . . ),

S3: set the glass blank 21 into the first and the second optical surface molds 51, 52 to be heated by a heater 225 and applied with pressure so as to mold a first lens array 11. The first lens array 11 includes 4×4 first optical surfaces and 4×4 second optical surfaces whose non-optical area is disposed with 4×4 glue grooves 111;

S4: manufacture a second lens array 12 according to the above method and the second lens array 12 includes 4×4 third optical surfaces and 4×4 fourth optical surfaces whose non-optical area is disposed with 4×4 circular V-shaped alignment notches 121(121a, 121b, . . . );

S5: apply the glue 13 to the glue groove 111 between two adjacent lens arrays 11, 12;

S6: use a laser beam 140 for alignment of optical axis 14, 14′ of the two lens arrays 11, 12;

S7: cure the glue 13 to form a stacked optical glass lens array 10 precisely aligned with the optical axis;

S8: connect two alignment notches 121 such as the alignment notch 121a and the alignment notch 121b of the lens array 10 to form two alignment marks 122, as shown in FIG. 4 and then connect the two alignment marks 122 to form a dicing line 15 along which the lens array 10 are singularized to 16 stacked optical lens elements 100;

S9: mount the stacked glass lens element 100 and other related optical elements into a lens holder 301 in turn to form a lens module 30.

In accordance with the above manufacturing method, the stacked optical glass lens array and the stacked lens module are produced precisely so as to achieve precise assembling and mass production.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A stacked optical glass lens array comprising at least two optical glass lens arrays that are stacked with each other by cement glue with a preset interval therebetween;
wherein the optical glass lens array is made by multi-cavity glass molding and having a plurality of optical glass lenses arranged to form an array with optical area and non-optical area;
wherein at least one glue groove for filling of cement glue is arranged at a periphery of the non-optical area so that the two adjacent optical glass lens arrays are assembled and stacked with each other with a preset interval.

2. The device as claimed in claim 1, wherein at least one alignment notch is disposed on a periphery of the non-optical area of at least one of the optical glass lens arrays.

3. The device as claimed in claim 2, wherein the alignment notches are circular and arranged to form an array while a center of each alignment notch is located on an optical axis of each optical glass lens.

4. The device as claimed in claim 1, wherein a spacer is disposed between the optical glass lens arrays and is stacked with the adjacent optical glass lens array by cement glue so as to generate a preset interval.

5. The device as claimed in claim 1, wherein the cement glue is thermoset glue that is cured by heating.

6. The device as claimed in claim 1, wherein the cement glue is UV curing glue that is cured by UV ray.

7. A stacked lens module comprising at least one stacked optical glass lens element, a lens holder and at least one optical element,
wherein the stacked optical glass lens element is a single element formed by cutting and singularizing of a stacked optical glass lens array,
wherein the stacked optical glass lens array includes at least two optical glass lens arrays and a glue groove for filling of cement glue is disposed on at least one of the two adjacent optical glass lens arrays so that the two adjacent optical glass lens arrays are assembled and stacked with each other by the cement glue with a preset interval; the lens holder is used to mount the stacked optical glass lens element and assemble with the optical element.

8. The device as claimed in claim 7, wherein the optical element is an optical glass lens, an aperture, a cover glass, an infrared-cut glass, an image sensor, a photoelectric device, a circuit board or their combinations.

9. A manufacturing method of a stacked optical glass lens array comprising the steps of:
S1: providing a glass blank;
S2: providing a first optical surface mold and a second optical surface mold of an optical lens array while the first optical surface mold and the second optical surface mold respectively having an optical surface molding surface; at least one of the first optical surface mold and the second optical surface mold is disposed with a glue groove molding surface;
S3: setting the glass blank into the first optical surface mold and the second optical surface mold to be heated and pressured so as to form an optical glass lens array while the optical glass lens array having optical area with optical surface and non-optical area with at least one glue groove;
S4: manufacturing another optical glass lens array according to the above to steps and this optical glass lens array is with or without the glue groove;
S5: applying cement glue to the glue groove between two adjacent stacked optical glass lens arrays;
S6: using a laser beam for alignment of optical axis of the two adjacent stacked optical glass lens arrays;
S7: curing the cement glue to form a stacked optical glass lens array.

10. The method as claimed in claim 8, wherein the step S4 further includes a step of arranging at least one alignment notch at the first optical surface mold or the second optical surface mold so as to form an alignment notch on the non-optical of the optical glass lens array.

11. A manufacturing method of a stacked lens module comprising the steps of:
SS1: providing a stacked optical glass lens array produced in the claim 9,
SS2: cutting the stacked optical glass lens array to form a plurality of a single stacked optical glass lens element;
SS3: mounting the stacked optical glass lens element into a lens holder and assemble with related optical element to form a stacked lens module.

12. A manufacturing method of a stacked lens module comprising the steps of:
SS1: providing a stacked optical glass lens array produced in the claim 10,
SS2: cutting the stacked optical glass lens array to form a plurality of a single stacked optical glass lens element;
SS3: mounting the stacked optical glass lens element into a lens holder and assemble with related optical element to form a stacked lens module.

13. The method as claimed in claim 11, wherein the step SS2 further includes a step of cutting along alignment marks formed by the alignment notches to form a plurality of a single stacked optical glass lens element.

14. The method as claimed in claim 12, wherein the step SS2 further includes a step of cutting along alignment marks formed by the alignment notches to form a plurality of a single stacked optical glass lens element.
